(19) United States
(12) Patent Application Publication
(10) Pub. No.: US 2026/0040228 A1
(43) Pub. Date: Feb. 5, 2026

(54) DEVICE OPERATION STATE TRANSITION

(71) Applicant: Samsung Electronics Co., Ltd., Suwon-si (KR)

(72) Inventor: Jeongho Jeon, San Jose, CA (US)

(21) Appl. No.: 19/262,041

(22) Filed: Jul. 7, 2025

Related U.S. Application Data
(60) Provisional application No. 63/677,170, filed on Jul. 30, 2024.

(51) Int. Cl. H04W 52/02; H04L 5/00; H04W 72/1273

(52) U.S. Cl. CPC H04W 52/0277; H04L 5/0048; H04W 72/1273

(57) ABSTRACT

Apparatuses and methods for device operation state transition. A method performed by an Internet of Things (IoT) device includes, in accordance with operation states of the IoT device, transmitting, to a reader, a channel or signal and receiving, from the reader, a channel or signal, and determining an operation state, from the operation states, to transition the IoT device to based on one or more timers or a device energy level. The operation states include an ON state, an OFF state, and a power saving (PS) state. The IoT device, in the OFF state, is not expected to transmit to or receive from the reader and not maintain a memory, in the ON state, is expected to transmit to or receive from the reader and maintain the memory, and, in the PS state, is not expected to transmit to or receive from the reader and maintain the memory.

### CROSS-REFERENCE TO RELATED AND CLAIM OF PRIORITY

The present application claims priority under 35 U.S.C. § 119 (e) to U.S. Provisional Patent Application No. 63/677,170 filed on Jul. 30, 2024, which is hereby incorporated by reference in its entirety.

### TECHNICAL FIELD

The present disclosure relates generally to wireless communication systems and, more specifically, the present disclosure is related to apparatuses and methods for device operation state transition.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to device operation state transition.

In one embodiment, an Internet of Things (IoT) device is provided. The IoT device includes a memory and a transceiver configured to in accordance with operation states of the IoT device, transmit, to a reader, a channel or signal that includes a device-to-reader (D2R) preamble and a physical device-to-reader channel (PDRCH) and receive, from the reader, a channel or signal that includes a reader-to-device (R2D) preamble and a physical reader-to-device channel (PRDCH). The operation states include an ON state, an OFF state, and a power saving (PS) state. The IoT device further includes processing circuitry operably coupled to the transceiver, and the memory. The processing circuitry is configured to determine an operation state, from the operation states, to transition to IoT device to based on one or more timers or a device energy level. In the OFF state, the IoT device (i) is not expected to transmit to or receive from the reader and (ii) does not maintain the memory. In the ON state, the IoT device (i) is expected to transmit to or receive from the reader and (ii) maintains the memory. In the PS state, the IoT device (i) is not expected to transmit to or receive from the reader and (ii) maintains the memory.

In another embodiment, a reader is provided. The reader includes a processor and a transceiver operably coupled to the processor. The transceiver is configured to receive, from an IoT device, a channel or signal that includes a D2R preamble and a PDRCH and transmit, to the IoT device, a channel or signal that includes a R2D preamble and a PRDCH. The IoT device operates according to operation states based on one or more timers or a device energy level. The operation states of the IoT device include an ON state, an OFF state, and a PS state. In the OFF state, the IoT device (i) is not expected to transmit to or receive from the reader and (ii) does not maintain a memory of the IoT device. In the ON state, the IoT device (i) is expected to transmit to or receive from the reader and (ii) maintains the memory. In the PS state, the IoT device (i) is not expected to transmit to or receive from the reader and (ii) maintains the memory.

In yet another embodiment, a method performed by an IoT device is provided. The method includes in accordance with operation states of the IoT device, transmitting, to a reader, a channel or signal that includes a D2R preamble and a PDRCH and receiving, from the reader, a channel or signal that includes a R2D preamble and a PRDCH. The operation states include an ON state, an OFF state, and a PS state. The method further includes determining an operation state, from the operation states, to transition the IoT device to based on one or more timers or a device energy level. In the OFF state, the IoT device (i) is not expected to transmit to or receive from the reader and (ii) does not maintain a memory. In the ON state, the IoT device (i) is expected to transmit to or receive from the reader and (ii) maintains the memory. In the PS state, the IoT device (i) is not expected to transmit to or receive from the reader and (ii) maintains the memory.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure using orthogonal frequency division multiplexing (OFDM) according to embodiments of the present disclosure;

FIG. 6 illustrates an example of a receiver structure using OFDM according to embodiments of the present disclosure;

FIG. 7 illustrates an example encoding structure for a downlink control information (DCI) format according to embodiments of the present disclosure;

FIG. 8 illustrates an example decoding structure for a downlink control information (DCI) format according to embodiments of the present disclosure;

FIG. 9 illustrates a diagram of an example type-1 backscatter structure for IoT devices according to embodiments of the present disclosure;

FIG. 10 illustrates a diagram of an example impedance matching circuit according to embodiments of the present disclosure;

FIG. 11 illustrates a diagram of an example type-2a backscatter structure for IoT devices according to embodiments of the present disclosure;

FIG. 12 illustrates a diagram of an example type-2a backscatter structure for IoT devices according to embodiments of the present disclosure;

FIG. 13 illustrates a diagram of an example type-2a backscatter structure for IoT devices according to embodiments of the present disclosure;

FIG. 14 illustrates a diagram of an example type-2b active structure for IoT devices according to embodiments of the present disclosure;

FIG. 15 illustrates a diagram of an example type-2b active structure for IoT devices according to embodiments of the present disclosure;

FIG. 16 illustrates a diagram of an example type-2b active structure for IoT devices according to embodiments of the present disclosure;

FIG. 17 illustrates an example system for device to reader (D2R)/reader to device (R2D) transmission involving an intermediate node according to embodiments of the present disclosure;

FIG. 18 illustrates an example signal architecture for A-IoT systems according to embodiments of the present disclosure;

FIG. 19 illustrates a diagram of example on and off states according to embodiments of the present disclosure;

FIG. 20 illustrates a flowchart of an example procedure for state transitions according to embodiments of the present disclosure;

FIG. 21 illustrates a diagram of example on, off, and power saving (PS) states according to embodiments of the present disclosure;

FIG. 22 illustrates a flowchart of an example procedure for state transitions according to embodiments of the present disclosure;

FIG. 23 illustrates a timeline of an example sequential device identification process according to embodiments of the present disclosure; and

FIG. 24 illustrates a timeline of an example multiplexed identification process according to embodiments of the present disclosure.

### DETAILED DESCRIPTION

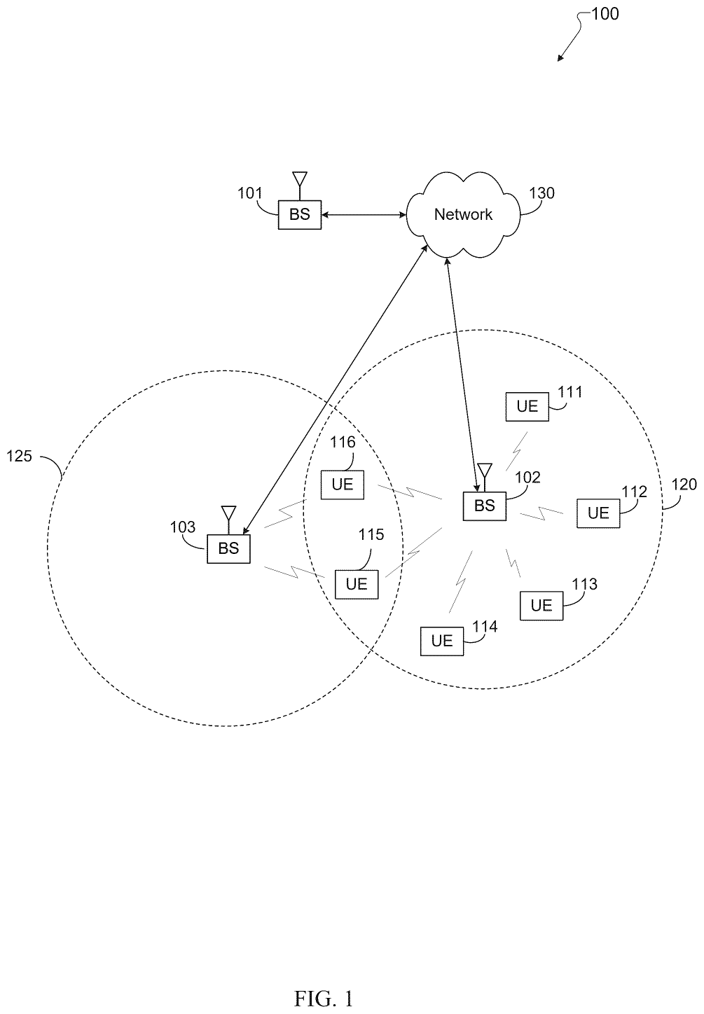

FIGS. 1-24, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [REF 1] 3GPP TS 38.211 v18.3.0, “NR; Physical channels and modulation;” [REF 2] 3GPP TS 38.212 v18.3.0, “NR; Multiplexing and channel coding;” [REF 3] 3GPP TS 38.213 v18.3.0, “NR; Physical layer procedures for control;” [REF 4] 3GPP TS 38.214 v18.3.0, “NR; Physical layer procedures for data;” [REF 5] 3GPP TS 38.331 v18.1.0, “NR; Radio Resource Control (RRC) protocol specification;” and [REF 6] 3GPP TS 38.321 v18.1.0, “NR; Medium Access Control (MAC) protocol specification.”

FIGS. 1-3 below describe various embodiments implemented in wireless communications systems and with the use of OFDM or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing a device operation state transition. In certain embodiments, one or more of the gNBs 101-103 include circuitry, programing, or a combination thereof to provide for device operation state transition.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

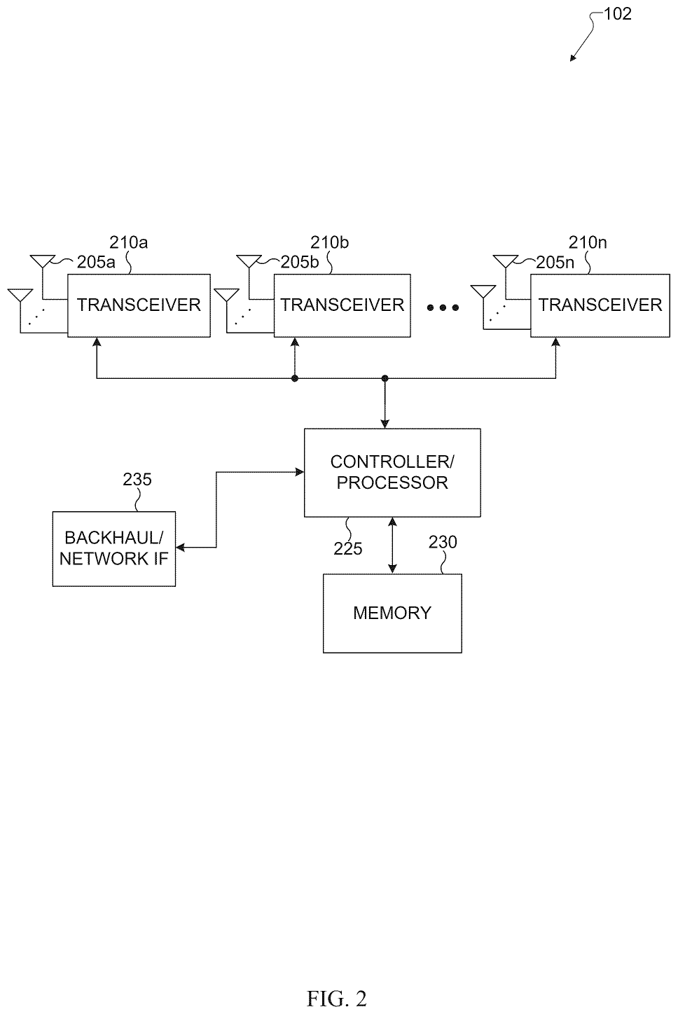

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as providing for a device operation state transition. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

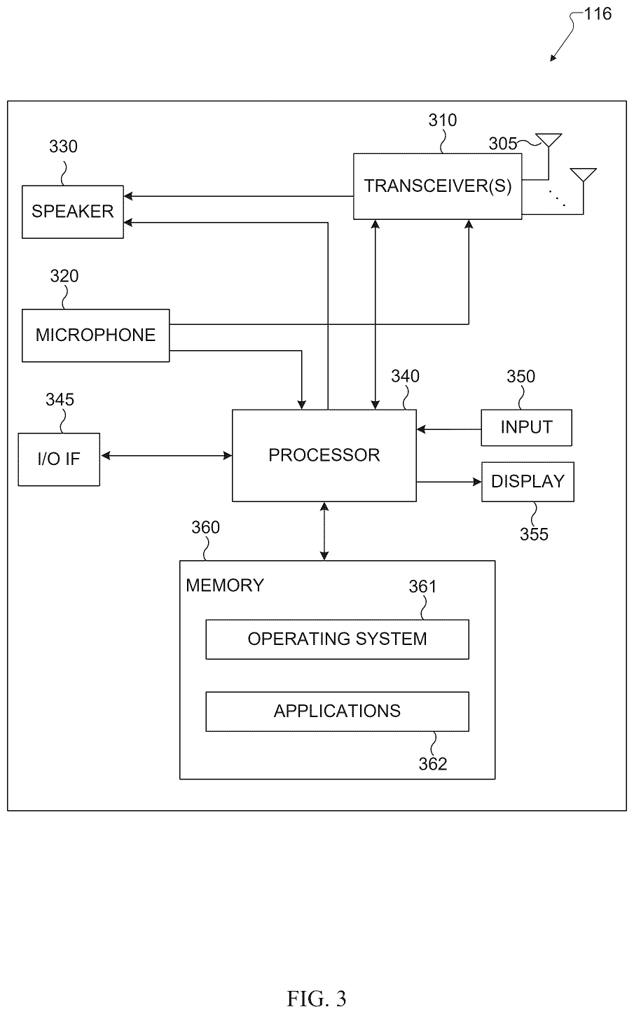

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to support a device operation state transition as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include volatile memory such as a random-access memory (RAM), and another part of the memory 360 could include non-volatile memory a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

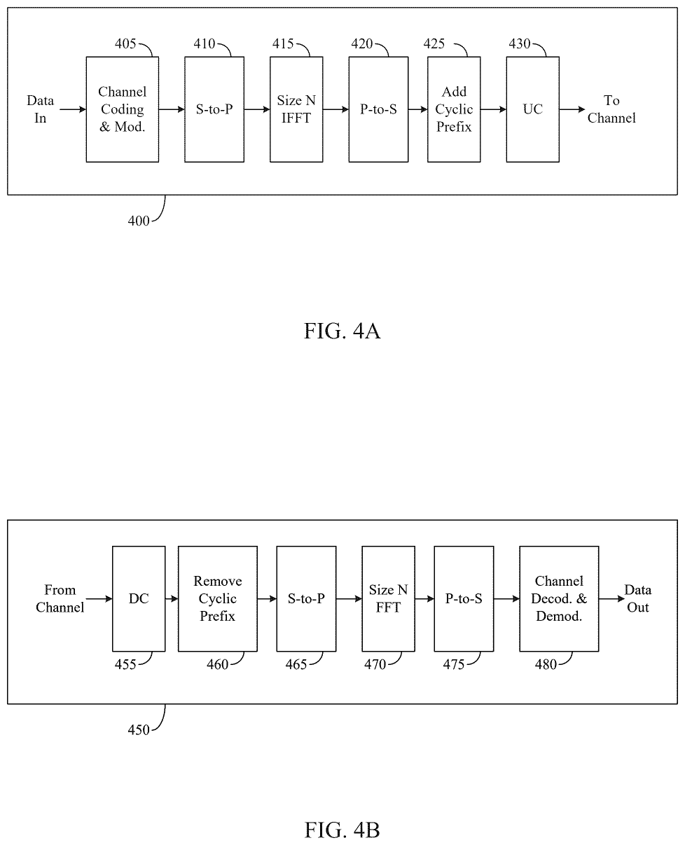

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for a device operation state transition as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Internet of things (IoT) devices include ambient-power-enabled IoT (A-IoT) devices, which are ultra-low-complexity devices with very small form factor and low-cost design that operate without a common battery that can be manually replaced or recharged. Instead, A-IoT devices can be battery-less or with a small battery (such as a small capacitor) that operate based on energy harvesting from RF waveforms or other ambient energy sources. Regarding the limited size and complexity required by practical applications for battery-less devices with no energy storage capability or devices with limited energy storage that do not need to be replaced or recharged manually, the output power of energy harvester is typically from 1 μW to a few hundreds of μW.

In various embodiments throughout the disclosure, a UE (e.g., the UE 116) or a device may be referred to as an A-IoT device or an A-IoT UE based on energy harvesting with ultra-low complexity and power consumption and for low-end IoT applications. For example, the UE may have limited (or no) energy storage or battery capability (e.g., a capacitor), such as an energy storage unit for amplification of receptions at the UE or transmission by the UE, or for other UE operations, such as power-on, warm-up, memory, internal processing, and so on, or operating with backscattering communication.

An A-IoT device can be an IoT device that satisfies one or more of the following (or variations thereof):
powered by energy harvesting, being either battery-less or with limited energy storage capability (e.g., using a capacitor) and the energy is provided through the harvesting of radio waves (including RF waveforms), light (including solar light or indoor light), motion, pressure, heat, or any other power source that could be seen suitable;
with low complexity, small size and lower capabilities and lower power consumption than previously defined 3GPP IoT devices (e.g., NB-IoT/enhanced machine type communication (eMTC) devices);
maintenance free and can have long life span (e.g., more than 10 years).

An A-IoT may directly communicate with a base station/gNB (e.g., the BS 102) (e.g., operating as a reader), or may indirectly communicate with a BS/gNB through an intermediate/assisting node, such as a handheld device/UE (for example, a “reader” UE that scans the A-IoT devices), a relay, integrated access and backhaul (IAB) node, a repeater for example a network-controlled repeater (NCR), and so on. The communication can be mono-static wherein the transmitter node to the A-IoT device is same as the receiving node from the A-IoT device, or can be bi-static (or multi-static) wherein the transmitter nodes to the A-IoT device can be different from the receiving nodes from the A-IoT device.

In various embodiments, the A-IoT device operates with energy storage and power management capability. These devices are characterized by ultra-low power consumption, and they employ energy harvesting mechanisms such as solar, RF energy and kinetic energy and thus don't require battery replacement or swapping frequently. In various embodiments, an A-IoT device operates with energy harvesting (EH) or with limited (or no) energy storage/battery capability (such as a capacitor), such as an energy storage unit for amplification of receptions at the UE (e.g., the UE 116) or transmission by the UE, or for other UE operations, such as power-on, warm-up, memory, internal processing, and so on, or operating with backscattering communication.

In various embodiments, the A-IoT device operates with RF envelope detection for receiving amplitude shift keying (ASK), e.g., OOK, modulated signal. RF envelope detection is a key function that enables the Ambient IoT devices to filter and analyze RF signals. This technique is applied in the reception of modulated RF signals with a view of acquiring information from the signals and hence enable communication between devices with efficiency and with minimum power consumption. RF envelope detection is one of the most important techniques that are used in many of the low power consumption wireless communication protocols that are employed in Ambient IoT systems.

In various embodiments, the A-IoT device may operate with impedance matching. Impedance matching may be utilized in passive Ambient IoT devices backscattering externally provisioned carrier wave (CW) signal.

The disclosure relates to defining functionalities and procedures for A-IoT device operations to transition states. DL and UL are also referred to as reader-to-device (R2D) and device-to-reader (D2R), respectively, and vice versa.

FIG. 5 illustrates an example of a transmitter structure 500 using OFDM according to embodiments of the present disclosure. For example, transmitter structure 500 using OFDM can be implemented in gNB 102 of FIG. 1. This example is for illustration only and other embodiments can be used without departing from the scope of the present disclosure.

Information bits, such as DCI bits or data bits 510, are encoded by encoder 520, rate matched to assigned time/frequency resources by rate matcher 530, and modulated by modulator 540. Subsequently, modulated encoded symbols and demodulation reference signal (DM-RS) or channel state information reference signal (CSI-RS) 550 are mapped to REs 560, an inverse fast Fourier transform (IFFT) is performed by filter 570. A BW selector unit 565, a filter 580, a radio frequency (RF) amplifier 590, and transmitted signal 595 are also included.

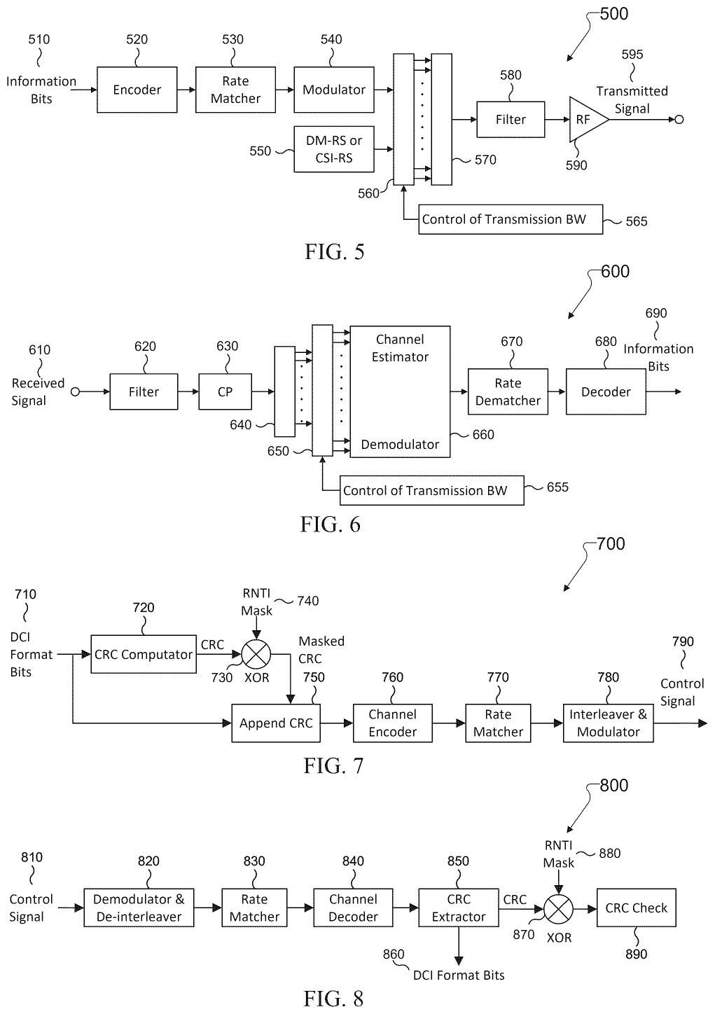

FIG. 6 illustrates an example of a receiver structure 600 using OFDM according to embodiments of the present disclosure. For example, receiver structure 600 using OFDM can be implemented by any of the UEs 111-116 of FIG. 1. This example is for illustration only and other embodiments can be used without departing from the scope of the present disclosure.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690.

With reference to FIG. 5, an example transmitter structure using OFDM according to this disclosure is shown.

With reference to FIG. 6, an example receiver structure using OFDM according to this disclosure is shown.

FIG. 7 illustrates an example encoding structure 700 for a downlink control information (DCI) format according to embodiments of the present disclosure. For example, encoding structure 700 can be implemented in gNB 102 of FIG. 1. This example is for illustration only and other embodiments can be used without departing from the scope of the present disclosure.

A gNB separately encodes and transmits each DCI format in a respective physical downlink control channel (PDCCH). When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR(0,0)=0, XOR(0,1)=1, XOR(1,0)=1, XOR(1,1)=0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted.

FIG. 8 illustrates an example decoding structure 800 for a DCI format according to embodiments of the present disclosure. For example, decoding structure 800 for a DCI format can be implemented by any of the UEs 111-116 of FIG. 1. This example is for illustration only and other embodiments can be used without departing from the scope of the present disclosure.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are regarded to be valid. When the CRC check does not succeed, the DCI format information bits are regarded to be invalid.

With reference to FIG. 7, an example encoding process for a DCI format according to this disclosure is shown.

With reference to FIG. 8, an example decoding process for a DCI format for use with a UE according to this disclosure is shown.

It is envisaged that the number of connected devices will reach ˜500 billion by 2030, which is about ˜59 times larger than the expected world population (˜8.5 billion) by that time. Mobile devices will take various form-factors, such as augmented reality (AR) glasses, virtual reality (VR) headsets, hologram devices, while a large portion of the devices will be Internet-of-Things (IoT) devices for improving productivity efficiency and increasing comforts of life. As the number of IoT devices grows exponentially, those IoT devices will become dominant in the next generation wireless communication systems such as fifth generation (5G) advanced, sixth generation (6G) systems, and so on.

With the explosive number of IoT devices, it may be challenging to power the IoT devices by battery that needs to be replaced or recharged manually, which leads to high maintenance cost. The automation and digitalization of various industries demand new IoT technologies of supporting batteryless devices with no energy storage capability or devices with energy storage that does not need to be replaced or recharged manually. Such types of devices are collectively termed as ambient IoT (A-IoT) in this disclosure, which is powered by various renewable energy sources such as radio waves, light, motion, or heat, etc. Use cases of A-IoT devices include asset inventory/tracking and remote environmental monitoring. The following list provides example use cases of A-IoT devices:
Indoor inventory
   Automated warehousing
   Medical instruments inventory management and positioning
   Non-Public Network for logistics
   Automobile manufacturing
   Airport terminal/shipping port
   Smart laundry
   Automated supply chain distribution
   Fresh food supply chain
   End-to-end logistics
   Flower auction
   Electronic shelf label
Indoor sensor
   Smart homes
   Base station machine room environmental supervision
   Smart laundry
   Smart agriculture
   Smart pig farm
   Cow stable
Indoor positioning
   Finding Remote Lost Item
   Location service
   Ranging in a home
   Personal belongings finding
   Positioning in shopping center
   Museum Guide
Indoor command
   Online modification of medical instruments status
   Device activation and deactivation
   Elderly Health Care
   Device Permanent Deactivation
   Electronic shelf label
Outdoor inventory
   Medical instruments inventory management and positioning
   Non-public network for logistics
   Airport terminal/shipping port
   Automated supply chain distribution
Outdoor sensor
   Smart grids
   Forest Fire Monitoring
   Dairy farming
   Smart manhole cover safety monitoring
   Smart bridge health monitoring
Outdoor positioning
   Finding remote lost item
   Location service
   Personal belongings finding
Outdoor command
   Online modification of medical instruments status
   Device activation and deactivation
   Elderly Health Care
   Controller in smart agriculture

Taking into account the limited size and low complexity required by practical applications of A-IoT devices, the output power of energy harvesting from ambient power sources is typically from 1 μW to a few hundreds of μW, which is orders of magnitude lower than normal user equipment (UE) having peak power consumption higher than 10 mW. This requires a new wireless access technology for A-IoT devices, which cannot be fulfilled by existing cellular systems including low-power IoT technologies such as NB-IoT and eMTC.

In the following, an italicized name for a parameter implies that the parameter is provided by higher layers.

DL (e.g., physical reader to device (R2D) channel (PRDCH)) transmissions or UL (e.g., PDRCH) transmissions can be based on an OFDM waveform including a variant using DFT precoding that is known as DFT-spread-OFDM that is typically applicable to UL transmissions.

In the following, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments provide a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in v17.6.0 of [REF 1] and v17.6.0 of [REF 3].

DCI can serve several purposes. A DCI format includes a number of fields, or information elements (IEs), and is typically used for scheduling a PDSCH (DL DCI format) or a PUSCH (UL DCI format) transmission. A DCI format includes cyclic redundancy check (CRC) bits in order for a UE (e.g., the UE 116) to confirm a correct detection. A DCI format type is identified by a radio network temporary identifier (RNTI) that scrambles the CRC bits. For a DCI format scheduling a physical downlink shared channel (PDSCH) or a PUSCH for a single UE with RRC connection to a gNB (e.g., the BS 102), the RNTI is a cell RNTI (C-RNTI) or another RNTI type such as a modulation and coding scheme-cell RNTI (MCS-C-RNTI). For a DCI format scheduling a PDSCH conveying system information (SI) to a group of UEs, the RNTI is a system information RNTI (SI-RNTI). For a DCI format scheduling a PDSCH providing a response to a random access (RA) from a group of UEs, the RNTI is a random access (RA-RNTI). For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a transmit power control radio network temporary identifier (TPC-RNTI), and so on. Each RNTI type is configured to a UE through higher layer signaling. A UE typically decodes at multiple candidate locations for PDCCH receptions as determined by an associated search space set.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element to resource element group (CCE-to-REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates

$${M}_{s}^{( L )}$$

per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in v17.6.0 of [REF2] or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number

$${n}_{s , f}^{μ}$$

in a frame with number n_{f} it

$$( {n}_{f} \cdot {N}_{slot}^{f r a m e , μ} + {n}_{s , f}^{μ} - {o}_{s} ) mod {k}_{s} = 0.$$

The UE monitors PDCCH candidates for search space set s for Tₛ consecutive slots, starting from slot

$${n}_{s , f}^{μ} ,$$

and does not monitor PDCCH candidates for search space set s for the next kₛ−Tₛ consecutive slots. The UE determines CCEs for monitoring PDCCH according to a search space set based on a search space equation as described in [REF3].

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving/scheduled cell based on a number of PDCCH candidates in respective search space sets for the corresponding active DL BWP. In the following, for brevity, that constraint for the number of DCI format sizes will be referred to as DCI size limit. When the DCI size limit would be exceeded for a UE based on a configuration of DCI formats that the UE monitors PDCCH, the UE aligns the size of some DCI formats, as described in v17.6.0 of [REF2], so that the DCI size limit would not be exceeded.

For each scheduled cell, the UE is not required to monitor on the active DL BWP with SCS configuration μ of the scheduling cell more than

$$min ( {M}_{P D C C H}^{max , slot , μ} , {M}_{P D C C H}^{t otal , slot , μ} )$$

PDCCH candidates or more than

$$min ( {C}_{P D C C H}^{max , slot , μ} , {C}_{P D C C H}^{t otal , slot , μ} )$$

non-overlapped CCEs per slot, wherein

$${M}_{P D C C H}^{max , slot , μ} and {C}_{P D C C H}^{t otal , slot , μ}$$

are respectively a maximum number of PDCCH candidates and nob-overlapping CCEs for a scheduled cell and

$${M}_{P D C C H}^{t otal , s1ot , μ} and {C}_{P D C C H}^{total , slot , μ}$$

are respectively a total number of PDCCH candidates and non-overlapping CCEs for a scheduling cell, as described in [REF3].

A UE does not expect to be configured CSS sets, other than CSS sets for multicast PDSCH scheduling, that result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot would exceed the limits/maximum per slot for scheduling on the primary cell mentioned herein, the UE selects the USS sets or the CSS sets to monitor corresponding PDCCH in an ascending order of a corresponding search space set index until and an index of a search space set for which PDCCH monitoring would result to exceeding the maximum number of PDCCH candidates or non-overlapping CCEs per slot for scheduling on the PCell as described in [REF3].

For same cell scheduling or for cross-carrier scheduling where a scheduling cell and scheduled cells have DL BWPs with same SCS configuration μ, a UE does not expect a number of PDCCH candidates, and a number of corresponding non-overlapped CCEs per slot on a secondary cell to be larger than the corresponding numbers that the UE is capable of monitoring on the secondary cell per slot. For cross-carrier scheduling, the number of PDCCH candidates for monitoring and the number of non-overlapped CCEs per slot are separately counted for each scheduled cell.

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in v17.6.0 of [REF3] and [REF4].

MIMO technologies have a key role in boosting system throughput both in NR and LTE and such a role will continue and further expand in the future generations of wireless technologies. For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

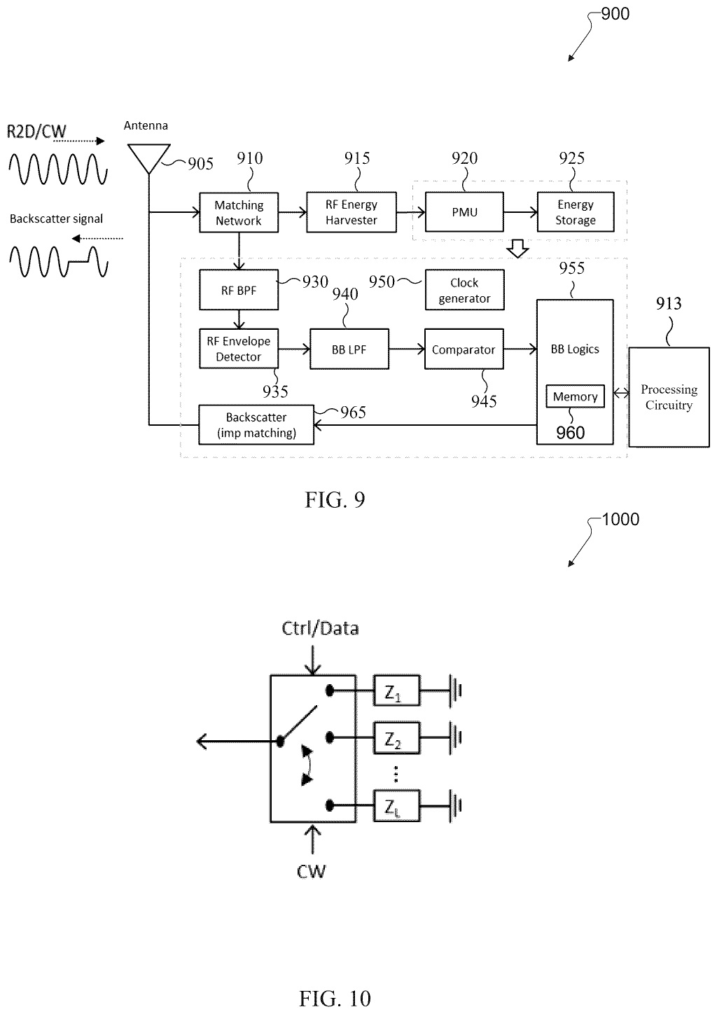

FIG. 9 illustrates a diagram of an example type-1 backscatter structure 900 for IoT devices according to embodiments of the present disclosure. For example, type-1 backscatter structure 900 can be implemented by any of the UEs 111-116 of FIG. 1, or may be devices with fewer components and functionality than a UE. This example is for illustration only and other embodiments can be used without departing from the scope of the present disclosure.

As shown in FIG. 9, the type-1 backscatter structure 900 for IoT devices includes an antenna 905, a matching network 910, a RF energy harvester 915, a power measurement unit (PMU) 920, an energy storage 925, a RF bandpass filter (BPF) 930, a RF envelope detector 935, a baseband (BB) lowpass filter (LPF) 940, a comparator 945, a clock generator 950, a BB logistics 955, a memory 960, backscatter (imp matching) 965, and processing circuitry 913.

In various embodiments, the processing circuitry 913, which may be a full-powered processor, such as included in UE 116, a lower-power microprocessor or microcontroller, an application specific integrated circuit (ASIC), or logic circuitry. The processing circuitry 913 can control the overall operation of the IoT device including determination of reception and/or transmission timing. The processing circuitry 913 may be powered via energy storage 925. The signal receiving and transmitting processing circuitry included in the IoT devices, such as RF BPF 930, a RF envelope detector 935, a BB LPF 940, a comparator 945, a clock generator 950, a BB logistics 955, a memory 960, and a backscatter (impedance matching) 965, may be referred to as a transceiver, which may use separate antennas for reception and transmission, respectively, or may use a common antenna, such as antenna 905 for transmission and reception. One or more implementations described herein further include other implementation variations such as separate Tx-Rx antennas vs common Tx-Rx antenna, use of a sensor, etc. The implementations should be understood as an example and not as a restriction.

FIG. 10 illustrates a diagram of an example impedance matching circuit according to embodiments of the present disclosure. For example, impedance matching circuit 1000 can be implemented in any of the IoT device described herein. This example is for illustration only and other embodiments can be used without departing from the scope of the present disclosure.

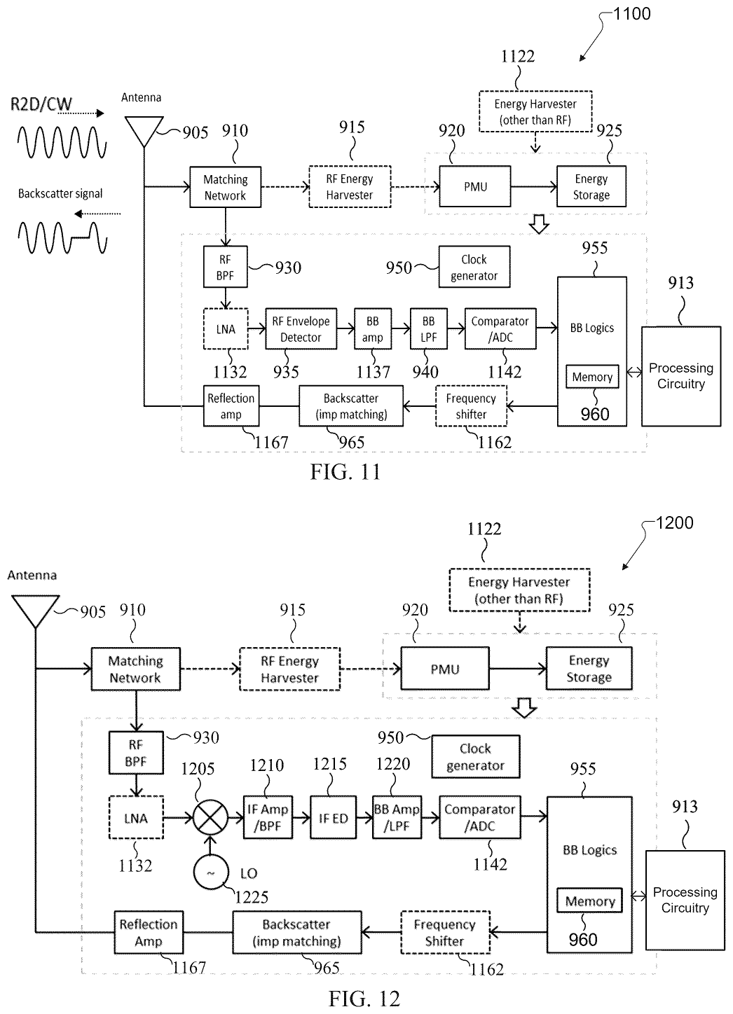

FIG. 11 illustrates a diagram of an example type-2a backscatter structure 1100 for IoT devices according to embodiments of the present disclosure. For example, backscatter structure 1100 can be implemented by any of the UEs 111-116 of FIG. 1, such as the UE 111, or may be devices with fewer components and functionality than a UE. This example is for illustration only and other embodiments can be used without departing from the scope of the present disclosure.

As shown in FIG. 11, the type-2a backscatter structure 1100 includes an antenna 905, a matching network 910, a RF energy harvester 915, a PMU 920, an energy storage 925, an energy harvester (other than RF) 1122, a RF BPF 930, a low noise amplifier (LNA) 1132, a RF envelope detector 935, a BB amp 1137, a BB LPF 940, a comparator/ADC 1142, a clock generator 950, a BB logistics 955, a memory 960, a frequency shifter 1162, backscatter (imp matching) 965, a reflection amp 1167, and processing circuitry 913.

FIG. 12 illustrates a diagram of an example type-2a backscatter structure 1200 for IoT devices according to embodiments of the present disclosure. For example, backscatter structure 1200 can be implemented by any of the UEs 111-116 of FIG. 1, such as the UE 112, or may be devices with fewer components and functionality than a UE. This example is for illustration only and other embodiments can be used without departing from the scope of the present disclosure.

As shown in FIG. 12, the type-2a backscatter structure 1200 includes an antenna 905, a matching network 910, a RF energy harvester 915, a PMU 920, an energy storage 925, an energy harvester (other than RF) 1122, a RF BPF 930, a LNA 1132, a mixer 1205, a LO 1225, an IF amp/BPF 1210, an IF ED 1215, a BB Amp/LPF 1220, a comparator/ADC 1142, a clock generator 950, a BB logistics 955, a memory 960, a frequency shifter 1162, a backscatter (impedance Matching) 965, reflection amp 1167, and processing circuitry 913.

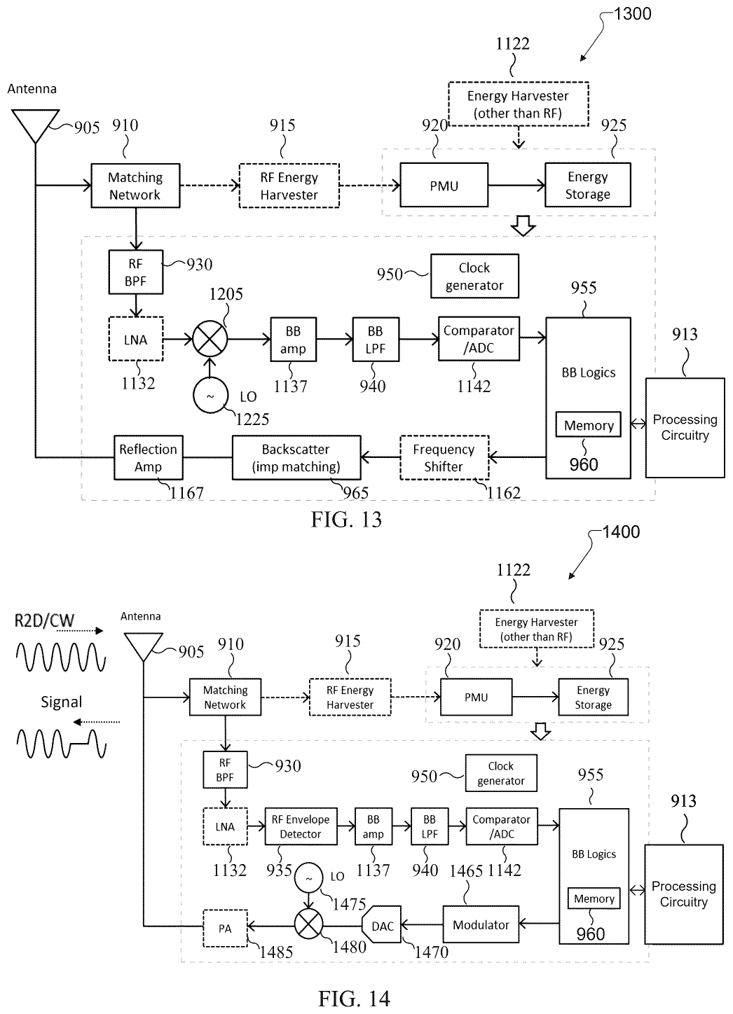

FIG. 13 illustrates a diagram of an example type-2b active structure 1300 for IoT devices according to embodiments of the present disclosure. For example, structure 1300 can be implemented by any of the UEs 111-116 of FIG. 1, such as the UE 113, or may be devices with fewer components and functionality than a UE. This example is for illustration only and other embodiments can be used without departing from the scope of the present disclosure.

As shown in FIG. 13, the type-2b active structure 1300 includes an antenna 905, a matching network 910, a RF energy harvester 915, a PMU 920, an energy storage 925, an energy harvester (other than RF) 1122, a RF BPF 930, a LNA 1132, a mixer 1205, an LO 1225, a BB amplifier 1137, a BB LPF 940, a comparator/ADC 1142, a clock generator 950, a BB logistics 955, a memory 960, a frequency shifter 1162, a backscatter (impedance matching) 965, a reflection amp 1167, and processing circuitry 913.

FIG. 14 illustrates a diagram of an example type-2b active structure 1400 for IoT devices according to embodiments of the present disclosure. For example, backscatter structure 1400 can be implemented by any of the UEs 111-116 of FIG. 1, such as the UE 114, or may be devices with fewer components and functionality than a UE. This example is for illustration only and other embodiments can be used without departing from the scope of the present disclosure.

As shown in FIG. 14, the type-2b active structure 1400 includes an antenna 905, a matching network 910, a RF energy harvester 915, a PMU 920, an energy storage 925, an energy harvester (other than RF) 1122, a RF BPF 930, a LNA 1132, a RF envelope detector 935, a BB amp 1137, a BB LPF 940, a comparator/ADC 1142, a clock generator 950, a BB logistics 955, a memory 960, a modulator 1465, a digital to analog converter (DAC) 1470, a LO 1475, a mixer 1480, a PA 1485, and processing circuitry 913.

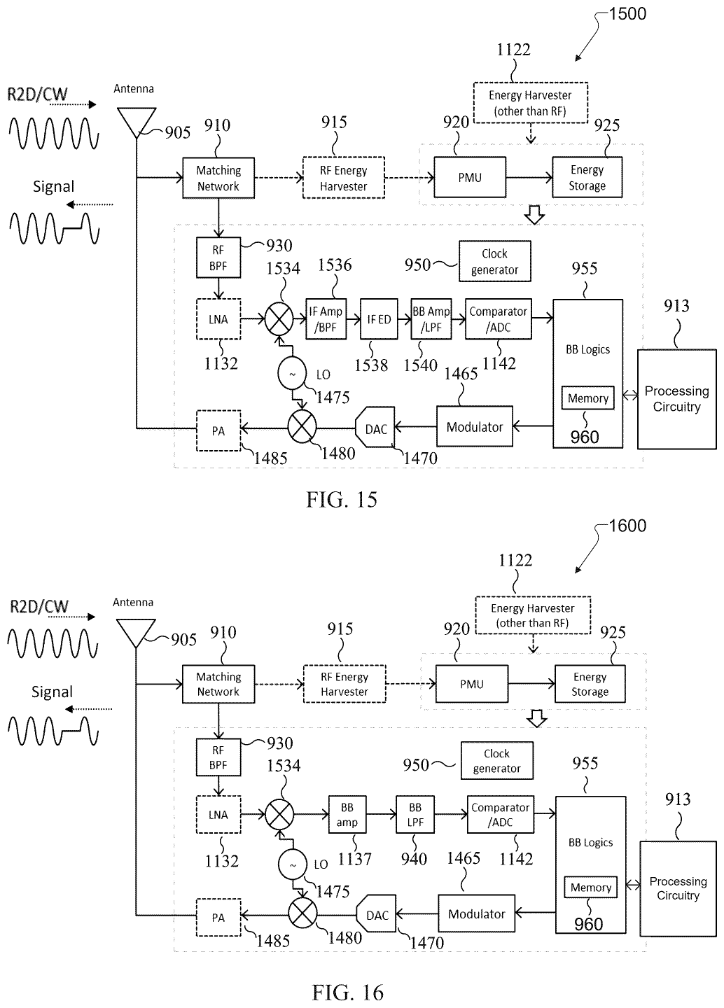

FIG. 15 illustrates a diagram of an example type-2b active structure 1500 for IoT devices according to embodiments of the present disclosure. For example, backscatter structure 1500 can be implemented by any of the UEs 111-116 of FIG. 1, such as the UE 115, or may be devices with fewer components and functionality than a UE. This example is for illustration only and other embodiments can be used without departing from the scope of the present disclosure.

As shown in FIG. 15, the structure 1500 includes an antenna 905, a matching network 910, a RF energy harvester 915, a PMU 920, an energy storage 925, an energy harvester (other than RF) 1122, a RF BPF 930, a LNA 1132, a mixer 1534, an IF amp/BPF 1536, an IF ED 1538, a BB amp/LPF 1540, a comparator/ADC 1142, a clock generator 950, a BB logistics 955, a memory 960, a modulator 1465, a DAC 1470, a LO 1475, a mixer 1480, a PA 1485, and processing circuitry 913.

FIG. 16 illustrates a diagram of an example type-2b active structure 1600 for IoT devices according to embodiments of the present disclosure. For example, backscatter structure 1600 can be implemented by any of the UEs 111-116 of FIG. 1, such as the UE 116, or may be devices with fewer components and functionality than a UE. This example is for illustration only and other embodiments can be used without departing from the scope of the present disclosure.

As shown in FIG. 16, the structure 1600 includes an antenna 905, a matching network 910, a RF energy harvester 915, a PMU 920, an energy storage 925, an energy harvester (other than RF) 1122, a RF BPF 930, a LNA 1132, a mixer 1534, a BB amp 1137, a BB LPF 940, a comparator/ADC 1142, a clock generator 950, a BB logistics 955, a memory 960, a modulator 1465, a DAC 1470, a LO 1475, a mixer 1480, a PA 1285, and processing circuitry 913.

Several different types of A-IoT devices can be regarded as following.
Device 1: ˜1 W peak power consumption, has energy storage, initial sampling frequency offset (SFO) up to 10× ppm, neither R2D nor D2R amplification in the device. The device's D2R transmission is backscattered on a carrier wave provided externally.
Device 2a: ≤a few hundred μW peak power consumption, has energy storage, initial sampling frequency offset (SFO) up to 10× ppm, both R2D and/or D2R amplification in the device. The device's D2R transmission is backscattered on a carrier wave provided externally.
Device 2b: ≤a few hundred μW peak power consumption, has energy storage, initial sampling frequency offset (SFO) up to 10× ppm, both R2D and/or D2R amplification in the device. The device's D2R transmission is generated internally by the device.

The devices may operate in frequency division duplexing (FDD) spectrum or time division duplexing (TDD) spectrum, which may be licensed or unlicensed.

In the following, reference architectures for the device types herein are provided, which should be understood as an example and not as a restriction.

With reference to FIG. 9, an example Type-1 backscatter device structure according to the disclosure is shown.

The RF energy harvester 915 converts RF signal to DC power and supplies the device. Either a R2D signal or an externally provisioned CW signal for backscattering can be utilized for RF energy harvesting. The CW is externally provided from a gNB or a dedicated source. The source of CW signal, e.g., either a gNB or a dedicated node, may or may not be agnostic to A-IoT devices. The harvested energy, e.g., using a rectifier, can be stored using a capacitor, super-capacitor, or, generally speaking, an energy storage. Antenna could be either shared or separate for RF energy harvester and receiver/transmitter. Matching network 910 is to match impedance between antenna and other components. Clock generator 950 provides required clock signal(s).

The PMU 920 manages storing energy to energy storage from energy harvester and supplying power to active component blocks which needs power supply. The PMU 920 can also transition the device operation state between at least ON state, the OFF state, and the power saving (PS) state. The PMU 920 includes or is implemented by power management circuitry. In some embodiments, the PMU 920 may be implemented by program code (e.g., software or firmware) executed by one or more processors such as the processing circuitry 913, such that, in some embodiments, the power management circuitry of the PMU 920 is the same as or includes at least some of the processing circuitry 913. In other embodiments, the power management circuitry of the PMU 920 may be a separate processor, controller, or circuit, such as a lower-power microprocessor or microcontroller, an ASIC, or logic circuitry that is programmed to implement the functions of the PMU 920 or configured to implement the functions of the PMU 920 in logic.

The R2D signal is demodulated using a low complexity envelope detector and comparator, whose output is provided as an input to the baseband circuit. Given the low-power and low-complexity requirements of the Type-1 backscatter device, an RF envelope detection can be a viable solution for a receiver architecture, compared to a heterodyne architecture with IF envelope detection or a homodyne architecture with baseband envelope detection, which require LO and frequency mixer for frequency down-conversion. The input RF signal passes through an RF band-pass filter (BPF) 930 for an adjacent channel interference suppression, and then the filtered RF signal is directly converted into a baseband using an RF envelope detector 935, followed by a baseband low-pass filter (LPF) 940 for filtering out harmonics and high frequency components, and an n-bit comparator, where n can be 1, 2, 4, 8, . . . . The use of filters, e.g., BPF 930 only, LPF 940 only, or both, can be an implementation choice.

For the D2R backscatter transmission, any of the following can be used:
Case 1) CW is provisioned at DL spectrum and backscattered, i.e., CW @ DL spectrum, D2R backscattering @ DL spectrum.
Case 2) CW is provisioned at UL spectrum and backscattered, i.e., CW @ UL spectrum, D2R backscattering @ UL spectrum.
Case 3) CW is provisioned at DL spectrum, frequency shifted to UL spectrum, and then backscattered, i.e., CW @ DL spectrum, D2R backscattering @ UL spectrum.

In one example, Case 1) or Case 2) is evaluated for device 1, i.e., CW and D2R backscattering on the same frequency and, therefore, a frequency shifter (FS) is not required.

With reference to FIG. 10, an example impedance matching circuit for backscatter device D2R modulation according to the disclosure is shown.

The followings are simple examples of impedance matching operations:
Open circuit: Full reflection of the received CW signal in the same phase. This can be used for OOK modulation with matching circuit.
Short circuit: Full reflection of the received CW signal in the reversed phase. This can be used for phase-shift keying (PSK) modulation.
Matching circuit: No reflection as the impedance is matched to a load, i.e., absorption. This can be utilized for energy harvesting, Rx mode, or modulation with other matching states.
Multi-level matching circuit: As illustrated in FIG. 10. Multi-level impedance matching to Z₁, Z₂, . . . , Z_{L} for log₂(L) bits per symbol ASK modulation.

Depending on the matched load impedance, the matching circuit can backscatter the incoming CW signal with different reflection coefficients in both amplitude and phase. In general, amplitude shift keying (ASK)/phase shift keying (PSK)/frequency shift keying (FSK) may be supported using an impedance matching circuit. As a simplest modulation scheme, OOK may be evaluated. The device may indicate its modulation capability or impedance matching capability to the network (e.g., the network 130), or certain requirement may be predefined in the specification of system operation.

With reference to FIG. 11, an example device 2a backscatter architecture based on RF envelope detection according to the disclosure is shown.

The device 2a may share similar structure at large with device 1 as the D2R transmission is still based on backscattering of an externally provided CW, while the device 2a may differ from device 1 from the following aspects.

The device 2a has ≤a few hundred μW peak power consumption and both R2D and/or D2R amplification in the device. In this case, alternative to the RF energy harvesting from a R2D signal or an externally provided CW signal, other renewable energy sources, e.g., solar, thermal, kinetic, etc., may be provided for energy harvesting. The presence of a certain energy harvesting capability from a certain renewable energy source may be expected for system design point of view. The use of energy harvesters, e.g., RF energy harvester 915 only, other energy harvester only, or both, can be an implementation choice.

The device 2a may be equipped with both R2D and/or D2R amplification in the device. Given the power consumption requirement, i.e., ≤a few hundred μW, the R2D/D2R amplification for device 2a may be based on an architecture that is different from the typical power amplifier (PA) and low noise amplifier (LNA). In some example low-power/complexity architectures for forward amplifier for reader-to-device (R2D) reception and reflection amplifier for device-to-reader (D2R) transmission, a single bipolar transistor terminated with microstrips may be used. The receiver amplification can be either RF amplification prior to the envelope detector, baseband amplification after the envelope detector, or both, which is an implementation choice. In one example, a reflection amplifier is used for both R2D reception and D2R transmission, and LNA may or may not exist. In another example, a reflection amplifier is used for D2R transmission only and LNA is used for R2D reception amplification.

In one example, a reflection amplifier can be used only for backscattering, i.e., one-way amplification. In another example, a reflection amplifier can be used for both backscattering and receiving, i.e., two-way amplification. For a reflection amplifier, it can be expected that 10˜25 dB gain is achievable, at a power consumption of a few tens to hundreds micro-Watts. It is noted that an exact power consumption value will be highly dependent on implementations. On the other hand, a stability of an amplifier is a function of an input impedance and operating frequency. Since A-IoT devices are expected to be deployed for a certain operating frequency and not expected to adapt to another frequency after deployment, the implementation can ensure a stable operation of the amplifier for the target frequency.

One additional difference of device 2a compared to device 1 may be a use of a FS. With a few hundred μW peak power consumption, some low-power LO architectures with a frequency mixer can be taken into account for Case 3). With FS, it can be expected that the CW is provided in a frequency different than the UL carrier frequency. Because the A-IoT devices are targeting for low complexity and low power consumption, the following options can be evaluated as an example method for frequency shift:
Ultra-low power local oscillator (LO), whose output frequency is multiplied in one or more stages using a frequency multiplier to obtain a desired amount of frequency shift.
Calibrated RC (resistor-capacitor) oscillator, which uses CW frequency as an input to the RC oscillator with phase locked loop (PLL) circuitry.
CW signal provided at the UL carrier frequency; In this case, no frequency shifter is needed.
Use of harmonic frequencies of CW signal or intermodulation frequencies of two-tone CW signals.

The device 2a receiver architecture may be based on RF envelope detector, intermediate frequency (IF) envelope detector (ED), i.e., heterodyne receiver, or homodyne receiver with zero IF, as exemplified for device 2b.

The device 2b shares similar structure at large with the device 2a other than the UL signal is internally generated using LO rather than backscattering the externally provided CW. The example architecture shown in FIGS. 12-14 is based on an active transmitter chain, wherein the UL data is modulated, converted to an analog signal using digital to analog converter (DAC) and, then up-converted to a UL carrier frequency using LO and frequency mixer, which is followed by an amplifier.

In FIG. 12, the DL receiver chain is still based on the RF envelope detector as in the previous architectures. In FIG. 13, the DL receiver chain is based on heterodyne receiver with IF envelope detector. In the heterodyne architecture, the RF signal is down converted into an intermediate frequency and then detected using an envelope detector. In FIG. 14, the DL receiver is based on homodyne receiver, i.e., zero-IF. In the homodyne/zero-IF architecture, the RF signal is directly down converted into baseband signal and then detected using a comparator/ADC.

FIGS. 9-14 should be understood for illustration purpose only. There can be other components not explicitly shown in the figure such as switch, duplexer, and filters, or some components may be replaced to different options. Also, the devices can operate both in TDD and FDD spectrum, either licensed or unlicensed, and, depending on the operating spectrum, the actual architectures can be different from the conceptual illustrations in the figures.

In deploying A-IoT devices, different topology options can be evaluated. The following provides examples of topology options:
Topology 1: BS↔A-IoT device.
   An A-IoT device directly and bidirectionally communicates with a basestation. The communication between the basestation and the A-IoT device includes A-IoT data and/or signalling. This topology includes the BS transmitting to the A-IoT device is different from the BS receiving from the A-IoT device.
Topology 2: BS↔intermediate node↔Ambient IoT device
   An A-IoT device communicates bidirectionally with an intermediate node between the device and basestation. In this topology, the intermediate node can be a relay, IAB node, UE, repeater, etc. which is capable of A-IoT. The intermediate node transfers A-IoT data and/or signalling between BS and the A-IoT device. The intermediate node is referred to as I-node in this disclosure.
Topology 3: BS↔assisting node↔Ambient IoT device↔BS
   An A-IoT device transmits data/signalling to a basestation, and receives data/signalling from the assisting node; or the A-IoT device receives data/signalling from a basestation and transmits data/signalling to the assisting node. In this topology, the assisting node can be a relay, IAB, UE, repeater, etc. which is capable of A-IoT.
Topology 4: UE↔Ambient IoT device
   An A-IoT device communicates bidirectionally with a UE. The communication between UE and the A-IoT device includes A-IoT data and/or signalling.

This disclosure is applicable at least to the following deployment scenarios:
Scenario 1: Device indoors, BS indoors
Scenario 2: Device indoors, BS outdoors
Scenario 3: Device indoors, UE-based reader
Scenario 4: Device outdoors, BS outdoors
Scenario 5: Device outdoors, UE-based reader

The deployment of A-IoT can be on the same sites as an existing 3GPP deployment corresponding to the BS type, e.g., macro-cell, micro-cell, pic-cell, etc. In some embodiments, it may be expected that the deployment of A-IoT can be on new sites without an expectation of an existing 3GPP deployment. The deployment can be based on licensed or unlicensed TDD or FDD spectrum, which may be in-band to an existing deployment, in guard-band of an existing deployment, or in a standalone band. Different traffic types can be supported including device-terminated (DT) and device-originated (DO), wherein DO traffic can be further divided into DO autonomous (DO-A), and DO device-terminated triggered (DO-DTT) types.

A-IoT device is one type of a UE. Embodiments in this disclosure can be generally applicable to other types of UEs, e.g., smartphones, AR/VR devices, or any other types of IoT devices.

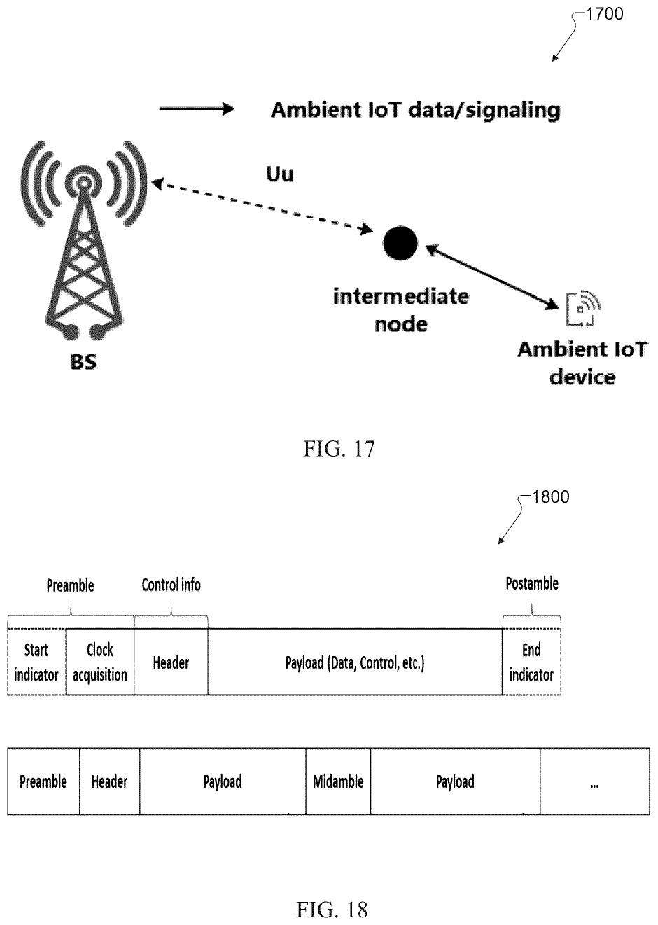

FIG. 17 illustrates an example system 1700 for D2R/R2D transmission including an intermediate UE according to embodiments of the present disclosure. For example, system 1700 can be implemented in the wireless network 100 of FIG. 1. This example is for illustration only and other embodiments can be used without departing from the scope of the present disclosure.

With reference to FIG. 17, a topology involving an intermediate node is shown, wherein the intermediate node (I-node) can be any of a UE, relay, repeater, a dedicated node, or a gNB (e.g., the BS 102). Any operations performed by a BS can be also performed by the I-node instead of the BS, and all or part of interfaces are transparent to the A-IoT devices.

An entity directly communicating with a device, or tag, is collectively termed as a reader, which can be an intermediate node as illustrated in FIG. 17, an assisting node, a UE, or a BS directly communicating with a device.

This disclosure is applicable to any of the following spectrum options, wherein a reader can be any of a BS, an intermediate node, an assisting node, or a UE in any of the topologies or scenarios disclosed herein:
CW is transmitted on DL spectrum and D2R is transmitted on the DL spectrum or shifted to UL spectrum.
CW is transmitted on UL spectrum and D2R is transmitted on the UL spectrum or shifted to DL spectrum.
R2D transmission by a reader is on DL spectrum or UL spectrum.
A node transmitting the CW can be a node inside the topology, e.g., a BS, an intermediate node, an assisting node, or a UE (e.g., the UE 116), or a node outside the topology, e.g., a dedicated CW source.
A reader receiving D2R transmission and a reader transmitting R2D may be the same or different.
As an example, CW is transmitted on DL spectrum and D2R transmission is shifted to UL spectrum, wherein the node transmitting the CW is a node inside topology or outside topology, and a reader transmitting R2D and a reader receiving D2R may be the same or different.
As another example, CW is transmitted on DL or UL spectrum and D2R transmission is on the same spectrum for which the CW is transmitted, wherein the node transmitting the CW is a node inside topology or outside topology, and a reader transmitting R2D and a reader receiving D2R may be the same or different.

A physical channel for reader to device transmission is referred to as a physical reader to device (R2D) channel (PRDCH), and a physical channel for device to reader transmission is referred to as a physical device to reader (D2R) channel (PDRCH) in this disclosure.

For PRDCH and PDRCH transmission, a timing acquisition signal, e.g., a preamble, is included at least for timing acquisition and for indicating the start of the transmission in time domain, respectively.

There may be a timing relationship between transmissions as herein:
T_{R2D_min}, T_{R2D_max}. Minimum/maximum time between a R2D transmission and the corresponding D2R transmission following it.
T_{D2R_min}, T_{D2R_max}: Minimum/maximum time between a D2R transmission and the corresponding R2D transmission following it.
T_{R2D_R2D_min}, T_{R2D_R2D_max}: Minimum/maximum time between two different consecutive R2D transmissions to the same A-IoT device.
T_{D2R_D2R_min}, T_{D2R_D2R_max}: Minimum/maximum time between two different consecutive D2R transmissions from the same A-IoT device.

FIG. 18 illustrates an example signal architecture 1800 for A-IoT systems according to embodiments of the present disclosure. For example, signal architecture 1800 can be received by any of the devices described herein. This example is for illustration only and other embodiments can be used without departing from the scope of the present disclosure.

With reference to FIG. 18, an example signal structure used for A-IoT system for R2D or D2R transmission is shown according to the disclosure. The dotted block indicates that it may or may not exist.

The first figure in FIG. 18 illustrates a general signal structure comprised of one or more of the following elements:
Start/End-indicator, i.e., delimiter: Start-of-signal and end-of-signal indication. It may be a short duration of low voltage signal or a sequence with low detection complexity prior to detecting preamble. The start-indicator is a part of the preamble. The end-indicator may be also termed as postamble. The delimiters may or may not be exist.
Clock acquisition: A sequence that provides OOK chip rate acquisition, which is used to detect OOK chips for the rest of the signal, and the chip synchronization. The clock acquisition part is a part of preamble.
Header: The header field carries necessary information for R2D or D2R signal reception, providing L1 or L2 control information
Payload: The field provides data including any of L1, L2, or higher layer control information, system information, etc.

The second figure in FIG. 18 illustrates a signal structure with midamble. When a transmission is longer than a certain threshold, which may be predefined in a specification of system operations or indicated to the device for reception or transmission from the device, the payload may be divided into multiple segments with midamble. A single header for the entire payload, or one or more headers for each segments of the payload may be provided. A single CRC for the entire payload (either inclusive or non-inclusive of the header) or one or more CRCs for each segments of the payload may be provided.

Depending on the energy level of the device, a device may or may not be able to transmit to or receive from a reader. Therefore, there is a need to define ON and OFF states of the device. Furthermore, there may be a device type with a larger energy storage. For those devices, there be an intermediate state between the ON and OFF states. For a fast transition into the ON state and for power saving of the device to prolong the device's sustainable operation time, there is another need to define an additional power saving (PS) state for the device.

For a device with ON and OFF states, there is a need to define state transition events between the ON and OFF states.

For a device with ON, OFF, and PS states, there is a need to define state transition events between the ON, OFF, and PS states.

During an inventory process, for a given random access round, a device may decide to not to perform random access to the reader. Therefore, for the remaining time of such random access round, the device does not need to stay in the ON state, as the device is not expected to receive from or transmit to the reader. Furthermore, if a device is identified earlier in a random access round of the inventory process, the device is not required to stay in the ON state for the remainder of the inventory process. Therefore, embodiments of the present disclosure recognize that there is a need to define state transitions for power saving during an inventory process.

The disclosure relates to a communication system. The disclosure relates to defining functionalities and procedures for communication with A-IoT devices which may be lacking a precise timing capability and may operate in a passive or active transmission mode.

The disclosure relates to defining device operation states based on the energy level of the device or to extend the device's sustainable operation time.

The disclosure also relates to defining functionalities and procedures for a device to perform state transitions between ON and OFF states.

The disclosure further relates to defining functionalities and procedures for a device to perform state transitions between ON, OFF and PS states.

The disclosure also relates to defining functionalities and procedures for a device to perform state transitions during inventory process for power saving.

Embodiments of the disclosure for communication with A-IoT devices, which may be lacking a precise timing capability and may operate in a passive or active UL transmission mode, are summarized in the following and are fully elaborated herein.
Method and apparatus for defining device operation states based on the energy level of the device or to extend the device's sustainable operation time.
Method and apparatus for a device to perform state transitions between ON and OFF states.
Method and apparatus for a device to perform state transitions between ON, OFF and PS states.
Method and apparatus for a device to perform state transitions during inventory process for power saving.

The general principle for device operation states is based on device energy level or predefined timer, which is not based on RRC configuration.

Depending on the implementation, a device has one or more of the following operation states:
OFF state: A device is not expected to transmit or receive a signal or a channel from a reader. A volatile memory is not maintained, while non-volatile memory is maintained. The device can be recharged via energy harvesting.
ON state: A device is expected to receive a signal or a channel from a reader. The device can transmit in response to a reception from the reader. Depending on the device implementation, e.g., antenna sharing or separate antennas for energy harvesting and signal reception, it may or may not be able to be recharged via energy harvesting, while the device is monitoring or receiving a signal or a channel from the reader. Both volatile and non-volatile memory are maintained.
Power Saving (PS) state: Both volatile and non-volatile memory are maintained. Therefore, counters or information received from a reader can be kept. In one example, a device is not expected to transmit or receive a signal or a channel from a reader in the PS state, and the device periodically transitions into the ON state to receive a signal or a channel from the reader. In another example, a device periodically monitors a signal or a channel from a reader in the PS state, and the device transitions into the ON state when a certain signal or channel addressed to the device, including broadcast, multicast, and groupcast, is received. In yet another example, a device periodically monitors a signal for a channel from a reader in the PS state, and the device transitions into the ON state when any signal or channel, not necessarily addressed to the device is received. Any signal or channel may be detected by preamble or energy, i.e., energy detection.

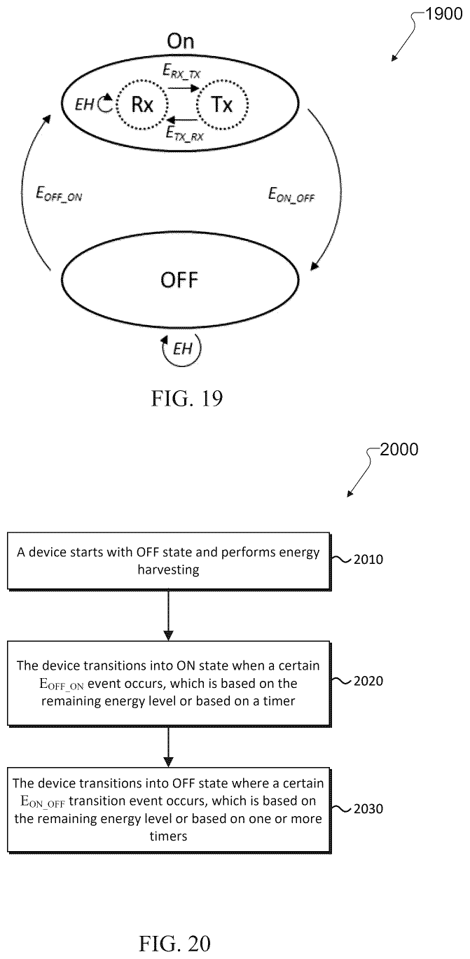

FIG. 19 illustrates a diagram of example on and off states 1900 according to embodiments of the present disclosure. For example, any of the devices described herein can transition within on and off states 1900. This example is for illustration only and other embodiments can be used without departing from the scope of the present disclosure.

In one example, device operation states include ON and OFF states and the device transitions between the ON and OFF states. The methods for transition between ON and OFF states can be apply to other scenarios in which the operation states include additional states, such as PS state.

With reference to FIG. 19, an example state diagram including ON and OFF states is shown according to the disclosure. Herein describes a list of state transition:
E_{OFF_ON}: state transition from OFF state to ON state.
E_{ON_OFF}: state transition from ON state to OFF state
E_{RX_TX}: state transition from reception state to transmission state within ON state
E_{TX_RX}: state transition from transmission state to reception state within ON state
EH: energy harvesting state self-transition

When a device transitions into ON state, the device enters RX state for monitoring a reception from a reader.

FIG. 20 illustrates a flowchart of an example procedure 2000 for state transitions according to embodiments of the present disclosure. For example, procedure 2000 can be performed by any of the devices described herein. This example is for illustration only and other embodiments can be used without departing from the scope of the present disclosure.

In 2010, a device starts with OFF state and performs energy harvesting. In another example, the device may start with ON state if the device has sufficient energy. In 2020, the device transitions into ON state when a certain E_{OFF_ON} event occurs, which is based on the remaining energy level or based on a timer. In 2030, the device transitions into OFF state where a certain E_{ON_OFF} transition event occurs, which is based on the remaining energy level or based on one or more timers. The use of timers may be further involved with a transmission or reception events.

With reference to FIG. 20, an example flowchart of a device to perform state transitions between ON and OFF states is shown according to the disclosure.

In one embodiment, the state transition between ON and OFF states, i.e., E_{OFF_ON} and E_{ON_OFF}, are based on energy level of the device. As an example, E_{OFF_ON} is triggered when the energy level exceeds a certain threshold, i.e., C>C_{OFF_ON}. The energy level may be in terms of percentage or absolute amount of remaining energy, e.g., μW, mW, in the energy storage of the device. Similarly, E_{ON_OFF} is triggered when the energy level goes below a certain threshold, i.e., C<C_{ON_OFF}. The energy threshold values may be predefined in a specification of system operations, indicated to the device, or left for implementational choice.

In this disclosure, the inequality > can be replaced by ≥ and, similarly, the inequality < can be replaced by ≤ without any further description.

In another embodiment, the state transition between ON and OFF states, i.e., E_{OFF_ON} and E_{ON_OFF}, are based on one or more timers and transmission or reception events. The transition E_{OFF_ON} is triggered as in the previous example, i.e., based on energy level, or based on a timer, if timer can be maintained during OFF state.

The timer starts when a device enters OFF state and, when the timer expires, denoted by TOFF, the device transitions into ON state. When a device transitions into ON state, the device stays in the ON state for monitoring a reception from a reader for a certain time duration, i.e., using a timer denoted by TON, such that reachability from a reader is guaranteed. When TON timer expires, the device may transition back to the OFF state. In one example, the timer value is set infinite or null, in which case the device stays in the ON state until the energy depletes or goes below a certain level. The timer values may be predefined in a specification of system operations, indicated to the device, or left for implementational choice. Alternatively, the timer values may be reported by the device to the reader, such as the minimum time that the device can stay in the ON state.

The on-duration timer, T_{ON}, may be interrupted and replaced by another timer, denoted by TRY ON, when a certain reception event occurs. The certain reception events can be such that when the device receives a certain signal or channel addressed to the device, including broadcast, multicast, and groupcast. The certain reception events can also be when any signal or channel, not necessarily addressed to the device is received. Any signal or channel may be detected by preamble or energy, i.e., energy detection. The timer may restart every time the certain reception event occurs.

The device may be triggered to transmit by the reader. In this case, the device transitions into TX state for the transmission, i.e., E_{RX_TX}, and then the device transitions back to the RX state after finishing the transmission, i.e., E_{TX_RX}. When the transmission event happens the current ongoing timer may be interrupted and replaced by another timer, denoted by T_{TX_ON}. The timer may restart every time the transmission event occurs. The timer, T_{TX_ON}, may be the same as the timer, T_{RX_ON}. When the current timer expires, the device transitions back to the OFF state, i.e., E_{ON_OFF}.

The device may also go into a micro-sleep state during the ON state for a minimum time duration between transmissions and receptions, i.e., T_{R2D_min}, T_{D2R_min}, T_{R2D_R2D_min}, T_{D2R_D2R_min}.

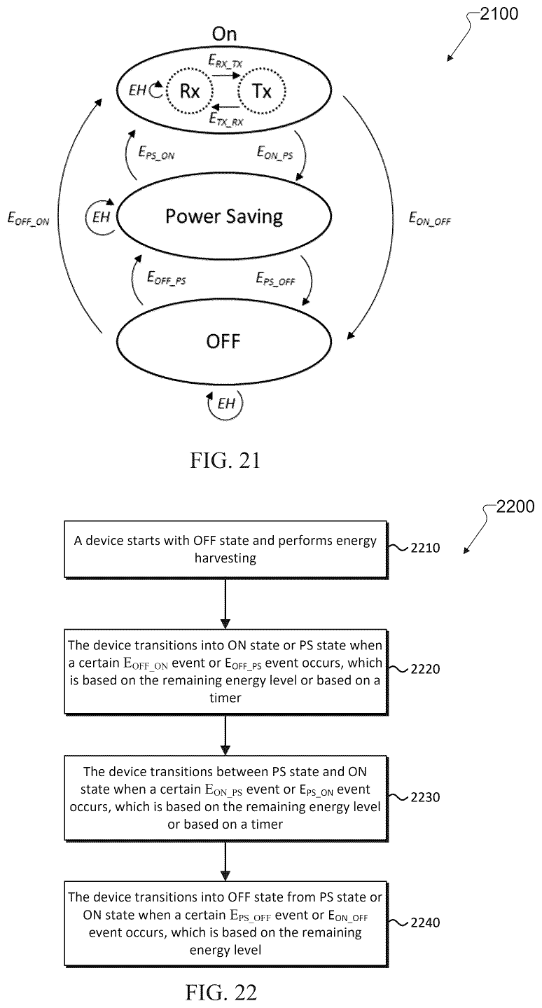

FIG. 21 illustrates a diagram of example on, off, and PS states 2100 according to embodiments of the present disclosure. For example, any of the devices described herein can transition within on, off, and PS states 2100. This example is for illustration only and other embodiments can be used without departing from the scope of the present disclosure.

In one example, device operation states include ON, OFF, and PS states and the device transitions between them.

With reference to FIG. 21, an example state diagram including ON, OFF, and PS states is shown according to the disclosure.

Herein describes a list of state transition in addition to those described for FIG. 19:
E_{OFF_PS}: state transition from OFF state to PS state.
E_{PS_ON}: state transition from PS state to ON state.
E_{ON_PS}: state transition from ON state to PS state
E_{PS_OFF}: state transition from PS state to OFF state

FIG. 22 illustrates a flowchart of an example procedure 2200 for state transitions according to embodiments of the present disclosure. For example, procedure 2200 can be performed by any of the devices described herein. This example is for illustration only and other embodiments can be used without departing from the scope of the present disclosure.

In 2210, a device starts with OFF state and performs energy harvesting. In 2220, the device transitions into ON state or PS state when a certain E_{OFF_ON} event or E_{OFF_PS} event occurs, which is based on the remaining energy level or based on a timer. In 2230, the device transitions between PS state and ON state when a certain E_{ON_PS} event or E_{PS_ON} event occurs, which is based on the remaining energy level or based on a timer. In 2240, the device transitions into OFF state from PS state or ON state when a certain E_{PS_OFF} event or E_{ON_OFF} event occurs, which is based on the remaining energy level.

With reference to FIG. 22, an example flowchart of a device to perform state transitions between ON, OFF, and PS states is shown according to the disclosure.

The state transition between the ON and the OFF states can be similar as before.

In one embodiment, a device transitions from the OFF state to ON state. In another embodiment, the device may first transition from the OFF state to the PS state, and then to the ON state. The state transition from the OFF state to the ON state, i.e., E_{OFF_ON}, or to the PS state, i.e., E_{OFF_PS}, may be based on the energy level of the device. As an example, E_{OFF_ON} is triggered when the energy level exceeds a certain threshold, i.e., C>C_{OFF_ON}, and E_{OFF_PS} is triggered when the energy level exceeds a certain threshold, i.e., C>C_{OFF_PS}. In one example, C_{OFF_ON} is greater than or equal to C_{OFF_PS}.

The state transition from the ON state to the PS state, i.e., E_{ON_PS}, can be based on the energy level of the device. As an example, EON Ps is triggered when the energy level goes below a certain threshold, i.e., C<C_{ON_PS}. In another example, the state transition from the ON state to the PS state can be based on a monitoring behavior such as the timer for the ON duration expires as disclosed earlier.

Similarly, the state transition from the PS state to the ON state, i.e., E_{PS_ON}, can be based on the energy level of the device. As an example, E_{PS_ON} is triggered when the energy level exceeds a certain threshold, i.e., C>C_{PS_ON}. In another example, the state transition can be based on a timer denoted by T_{PS}, such that the device transitions when the timer expires. The timer values may be predefined in a specification of system operations, indicated to the device, or left for implementational choice. Alternatively, the timer values may be reported by the device to the reader based on the factors such as the charging rate and the discharging rate.

In the PS state, the devices expected to perform energy harvesting. However, the charging rate in the PS state can be slower than the discharging rate in the state for maintaining basic functional blocks such as memories and counting operations. In this case, the device may perform a state transition from the PS state to the OFF state. The state transition from the PS state to the OFF state, i.e., E_{PS_OFF}, can be based on the energy level of the device. As an example, E_{PS_OFF} is triggered when the energy level goes below a certain threshold, i.e., C<C_{PS_OFF}. In one example, when the device transitions from the PS state to the OFF state, the device may provide a power turning-off indication to a reader.

The state transition from the ON state to the OFF state, i.e., E_{ON_OFF}, can be based on the energy level of the device. As an example, E_{ON_OFF} is triggered when the energy level goes below a certain threshold, i.e., C<C_{ON_OFF}. In one example, C_{ON_OFF} is less than or equal to C_{ON_PS}.

Any of the energy level threshold values or the timer values for the state transition may be predefined in a specification of system operations, indicated to the device, reported by a device to a reader, or left for implementational choice. When the timer value is indicated to the device, a reader provides the timer value in the PRDCH transmission such as T_{PS}, for indicating the next wake-up occasion from the PS state to the ON state.

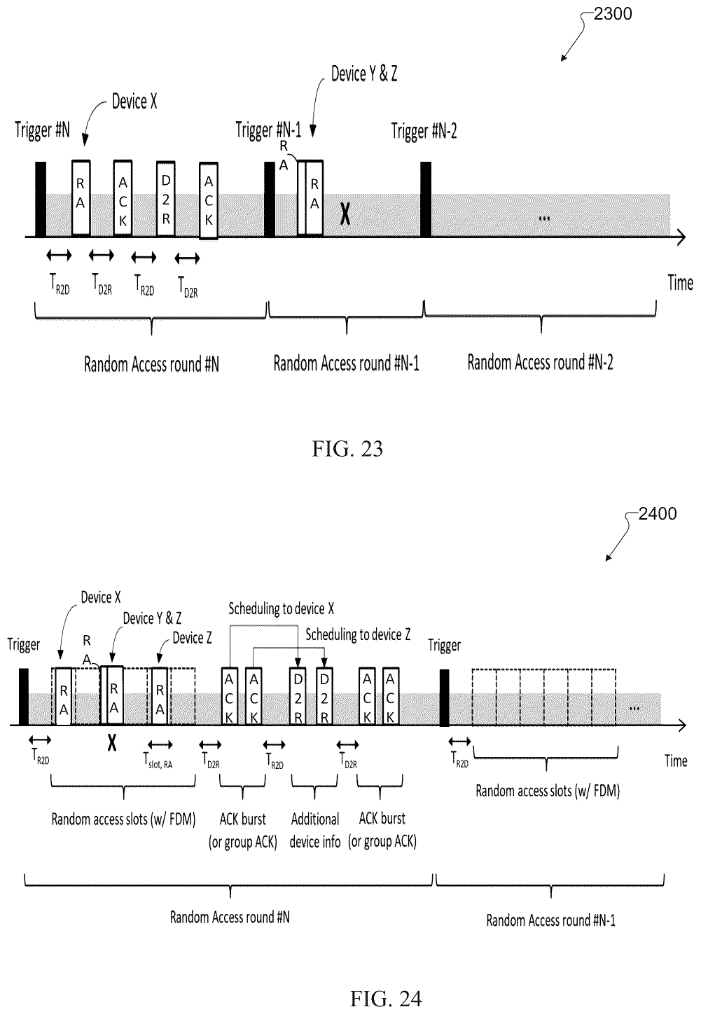

FIG. 23 illustrates a timeline 2300 of an example sequential device identification process according to embodiments of the present disclosure. For example, timeline 2300 can be followed by any of the readers described herein and any of the devices described herein. This example is for illustration only and other embodiments can be used without departing from the scope of the present disclosure.

With reference to FIG. 23, a sequential device identification process via random access is shown according to the disclosure.

In the sequential device identification process via random access, device identification is performed for one device in one random access round. The figure is illustrated for time domain operation. It can be understood that the operation can be both in time and frequency domain, i.e., the Step 1 PDRCH transmission may involve a random time/frequency resource selection.

As illustrated in the figure, a PRDCH transmission providing a trigger indicates a start of a random access round. In one example, the time intervals between two consecutive triggers are fixed. In another example, the time intervals between two consecutive triggers are variable. For instance, a reader may early terminate the random access round, if no PDRCH transmission is successfully received, by transmitting the next PRDCH providing a trigger early.

In one example, the trigger message may provide a current random access round index as the round progresses, i.e., N, N−1, N−2, . . . , 1. In another example, the trigger message provides the total number of random access rounds, i.e., N, repeatedly.

A device randomly determine the medium access, for instance, using one of the following methods:
The device may draw a Bernoulli random variable using an access probability PA. If an outcome is positive, the device randomly selects one random access round for random access. If the outcome is negative, the device does not participate in the current set of random access rounds.
In another example, the access probability is applied per random access round. For example, in each round, the device draws a Bernoulli random variable and decides whether to access the medium or not.
In yet another example, for a given round, the device draws a uniform discrete random variable from a certain range, e.g., [0, 2^{N}−1] or [1, 2^{N}], and, if the drawn random variable is n, whose value is predefined, e.g., zero or 1, or indicated to the device, the device attempts random access in the given random access round.
In yet another example, the device draws a random number from a certain range, and the drawn random number is counted down in every trigger message. The device then performs random access when the countdown finishes.

FIG. 24 illustrates a timeline 2400 of an example multiplexed identification process according to embodiments of the present disclosure. For example, timeline 2400 can be followed by any of the readers described herein and any of the devices described herein. This example is for illustration only and other embodiments can be used without departing from the scope of the present disclosure.

With reference to FIG. 24, a multiplexed device identification process via random access is shown according to the disclosure.

The figure is illustrated for time domain operation. It can be understood that the operation can be both in time and frequency domain, i.e., the Step 1 PDRCH transmission may involve a random time/frequency resource selection.

As in the previous sequential identification example, a PRDCH transmission providing a trigger indicates a start of a random access round, the time intervals between two consecutive triggers may be fixed or variable, and the trigger message may provide a current random access round index as the round progresses or provides the total number of random access rounds repeatedly.

The trigger message provides a number of time slots and/or frequency resources following the trigger message no earlier than T_{R2D} time interval. The random access slot duration, T_{slot, RA} may be predefined or indicated to the device in the trigger message.

A device randomly determine the medium access, for instance, using one of the following methods:
The device may draw a Bernoulli random variable using an access probability P_{A}. If an outcome is positive, the device randomly selects one random access round for random access. For the given random access round, the device randomly selects one time and/or frequency resource from the set of resources. If the outcome is negative, the device does not participate in the current set of random access rounds.
In another example, the access probability is applied per random access round. For example, in each round, the device draws a Bernoulli random variable and decides whether to access the medium or not. If the device decided to access, for the given random access round, the device randomly selects one time and/or frequency resource from the set of resources.
In yet another example, for a given round, the device draws a uniform discrete random variable from a certain range, e.g., [0, 2^{N}−1] or [1, 2^{N}], and, if the drawn random variable is n, whose value is predefined, e.g., zero or 1, or indicated to the device, the device attempts random access in the given random access round by randomly selecting one time and/or frequency resource from the set of resources.
In yet another example, for a given time slot in a given random access round, the device draws a uniform discrete random variable from a certain range, e.g., [0, 2^{N}−1] or [1, 2^{N}], and, if the drawn random variable is n, whose value is predefined, e.g., zero or 1, or indicated to the device, the device attempts random access.

In one embodiment, there is a minimum time between any two trigger messages denoted by T_{trigger_min}. Similarly, there is a maximum time between two consecutive trigger messages of an inventory process, denoted by T_{trigger_max}.

For a given random access round initiated by a trigger message, a device may or may not perform random access based on a determination method as disclosed earlier. If the device decides to not to perform random access for the given random access round, the device can transition into the PS or OFF state with the timer value T_{trigger_min}. After the expiration of the timer in the PS or OFF state, the device transitions back to the ON state to monitor a trigger message from the reader. After waking up, i.e., E_{PS_ON}, E_{OFF_ON}, the device monitors a trigger during [0, T_{trigger_max}−T_{trigger_min}]. If no trigger is detected, the device expects that the inventory process is ended and performs normal state transition operation as disclosed earlier.

If a device is successfully inventoried, the device does not need to participate in the remaining random access rounds of the current inventory process. Therefore, in one embodiment, the device transitions into PS or OFF state with a certain timer denoted by T_{inventoried}. T_{inventoried} may be predefined in a specification of system operations, indicated to the device, or calculated by a device.

When the timer value is indicated to the device, a reader provides the timer value in the PRDCH transmission, e.g., based on the predicted finish time of the current inventory process.

When the timer value is calculated by the device, the determination can be based on the remaining inventory rounds indicated in the trigger messages, as disclosed earlier, and/or the minimum time between the rounds, i.e., T_{trigger_min}. As an example, if the remaining inventory rounds is K, then the timer is calculated as T_{inventoried}=K·T_{trigger_min}. After the device transitions back to the ON state after the expiration of the timer, T_{inventoried}, the current inventory process is still on-going as the calculated timer is based on the minimum time between the trigger messages. Based on the received trigger message after waking up, and the remaining inventory rounds provided in the trigger message, the device recalculates the remaining inventory process as disclosed herein and the device goes back to the OFF or PS state with the newly calculated timer value. This may be repeated until the current inventory process actually finishes. In one example, the calculated timer value by the device may be reported to the reader.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. An Internet of Things (IoT) device comprising:
a memory;
a transceiver configured to, in accordance with operation states of the IoT device:
transmit, to a reader, a channel or signal that includes a device-to-reader (D2R) preamble and a physical device-to-reader channel (PDRCH); and
receive, from the reader, a channel or signal that includes a reader-to-device (R2D) preamble and a physical reader-to-device channel (PRDCH), wherein the operation states include an ON state, an OFF state, and a power saving (PS) state;
processing circuitry operably coupled to the transceiver, and the memory, the processing circuitry configured to determine an operation state, from the operation states, to transition the IoT device to based on one or more timers or a device energy level, wherein:
in the OFF state, the IoT device (i) is not expected to transmit to or receive from the reader and (ii) does not maintain the memory,
in the ON state, the IoT device (i) is expected to transmit to or receive from the reader and (ii) maintains the memory, and
in the PS state, the IoT device (i) is not expected to transmit to or receive from the reader and (ii) maintains the memory.

2. The IoT device of claim 1, wherein:
the PRDCH includes an initial value from the one or more timers, and
the one or more timers include at least a timer to transition the operation state from the PS state to the ON state when the timer expires.

3. The IoT device of claim 1, wherein the PDRCH includes a power turning-off indication when the operation state transitions to the OFF state from the ON state or from the PS state.

4. The IoT device of claim 1, wherein the one or more timers include at least a timer to maintain the ON state when the operation state transitions to the ON state from the OFF state or from the PS state.

5. The IoT device of claim 1, wherein:
the one or more timers include at least a timer to maintain the ON state when the operation state transitions to the ON state from the OFF state or from the PS state,
the timer to maintain the ON state is reinitialized with an initial value upon a transmission to or a reception from the reader, and
the initial value is either the same or different from a previous initial value.

6. The IoT device of claim 1, wherein:
the PRDCH includes a message triggering a random access occasion,
the processing circuitry is further configured to:
determine whether to transmit the PDRCH in the random access occasion, and
in response to a determination to not transmit the PDRCH in the random access occasion:
determine to transition to the PS state or to the OFF state from the ON state,
maintain the PS state or the OFF state using a timer from the one or more timers, and
determine to transition to the ON state from the PS state or from the OFF state when the timer expires.

7. The IoT device of claim 1, wherein:
the PRDCH includes a message triggering a random access occasion,
the processing circuitry is further configured to, in response to successful completion of random access:
determine to transition to the PS state or to the OFF state from the ON state, and
maintain the PS state or the OFF state using a timer from the one or more timers, and
an initial value of the timer is provided in another reception of the PRDCH or calculated by the IoT device based on an index of the random access occasion.

8. A reader comprising:
a processor; and
a transceiver operably coupled to the processor, the transceiver configured to:
receive, from an Internet of Things (IoT) device, a channel or signal that includes a device-to-reader (D2R) preamble and a physical device-to-reader channel (PDRCH); and
transmit, to the IoT device, a channel or signal that includes a reader-to-device (R2D) preamble and a physical reader-to-device channel (PRDCH),
wherein the IoT device operates according to operation states based on one or more timers or a device energy level,
wherein the operation states of the IoT device include an ON state, an OFF state, and a power saving (PS) state, and
wherein:
in the OFF state, the IoT device (i) is not expected to transmit to or receive from the reader and (ii) does not maintain a memory of the IoT device,
in the ON state, the IoT device (i) is expected to transmit to or receive from the reader and (ii) maintains the memory, and
in the PS state, the IoT device (i) is not expected to transmit to or receive from the reader and (ii) maintains the memory.

9. The reader of claim 8, wherein:
the PRDCH includes an initial value from the one or more timers, and
the one or more timers include at least a timer to transition the operation state from the PS state to the ON state when the timer expires.

10. The reader of claim 8, wherein the PDRCH includes a power turning-off indication when the operation state transitions to the OFF state from the ON state or from the PS state.

11. The reader of claim 8, wherein the one or more timers include at least a timer to maintain the ON state when the operation state transitions to the ON state from the OFF state or from the PS state.

12. The reader of claim 8, wherein:
the one or more timers include at least a timer to maintain the ON state when the operation state transitions to the ON state from the OFF state or from the PS state,
the timer to maintain the ON state is reinitialized with an initial value upon a transmission to or a reception from the IoT device, and
the initial value is either the same or different from a previous initial value.

13. The reader of claim 8, wherein:
the PRDCH includes a message triggering a random access occasion, and
when the PDRCH is not received in the random access occasion, the processor is further configured to identify that IoT device:
transitions to the PS state or to the OFF state from the ON state,
maintains the PS state or the OFF state using a timer from the one or more timers, and
transitions to the ON state from the PS state or the OFF state when the timer expires.

14. The reader of claim 8, wherein:
the PRDCH includes a message triggering a random access occasion, and
after successful completion of random access, the processor is further configured to identify that IoT device:
transitions to the PS state or to the OFF state from the ON state, and
maintains the PS state or the OFF state using a timer from the one or more timers, and
an initial value of the timer is provided in another transmission of the PRDCH or calculated by the IoT device based on an index of the random access occasion.

15. A method performed by an Internet of Things (IoT) device, the method comprising:
in accordance with operation states of the IoT device:
transmitting, to a reader, a channel or signal that includes a device-to-reader (D2R) preamble and a physical device-to-reader channel (PDRCH); and
receiving, from the reader, a channel or signal that includes a reader-to-device (R2D) preamble and a physical reader-to-device channel (PRDCH), wherein the operation states include an ON state, an OFF state, and a power saving (PS) state,
determining an operation state, from the operation states, to transition the IoT device to based on one or more timers or a device energy level, wherein:
in the OFF state, the IoT device (i) is not expected to transmit to or receive from the reader and (ii) does not maintain a memory of the IoT device,
in the ON state, the IoT device (i) is expected to transmit to or receive from the reader and (ii) maintains the memory, and
in the PS state, the IoT device (i) is not expected to transmit to or receive from the reader and (ii) maintains the memory.

16. The method of claim 15, wherein:
the PRDCH includes an initial value from the one or more timers, and
the one or more timers include at least a timer to transition the operation state from the PS state to the ON state when the timer expires.

17. The method of claim 15, wherein the PDRCH includes a power turning-off indication when the operation state transitions to the OFF state from the ON state or from the PS state.

18. The method of claim 15, wherein the one or more timers include at least a timer to maintain the ON state when the operation state transitions to the ON state from the OFF state or from the PS state.

19. The method of claim 15, wherein:
the one or more timers include at least a timer to maintain the ON state when the operation state transitions to the ON state from the OFF state or from the PS state,
the timer to maintain the ON state is reinitialized with an initial value upon a transmission to or a reception from the reader, and
the initial value is either the same or different from a previous initial value.

20. The method of claim 15, wherein:
the PRDCH includes a message triggering a random access occasion,
the method further comprises:
determining whether to transmit the PDRCH in the random access occasion, and
in response to determining to not transmit the PDRCH in the random access occasion:
determining to transition to the PS state or to the OFF state from the ON state,
maintaining the PS state or the OFF state using a timer from the one or more timers, and
determining to transition to the ON state from the PS state or the OFF state when the timer expires.
